(19) United States
(12) Patent Application Publication
(10) Pub. No.: US 2007/0221443 A1
(43) Pub. Date: Sep. 27, 2007

(54) Ladder stabilizing system

(76) Inventor: Steven E. Nelson, Punta Gorda, FL (US)

Correspondence Address: HARNESS, DICKEY & PIERCE, P.L.C., P.O. BOX 828, BLOOMFIELD HILLS, MI, 48303, US

(21) Appl. No.: 11/725,955

(22) Filed: Mar. 20, 2007

Related U.S. Application Data
(60) Provisional application No. 60/786,061, filed on Mar. 24, 2006.

(51) Int. Cl. E06C 7/42

(52) U.S. Cl. 182/108

(57) ABSTRACT

A ladder stabilizer boot for providing stability to a ladder during use upon softer substrate, such as loose soil, sod, sand, or gravel, preventing the sinking of the ladder leg into the ground, causing the ladder to tilt and possibly throwing off the balance of the user, causing injury. Molded of a single element, each stabilizer boot comprises a generally planar base, with a channel for receiving and frictionally holding the bottom end of a rectangular cross-section ladder leg therewithin. Alternatively, the ladder boot may be utilized on smooth surface, wherein an anti-skid texture on the bottom of the base provides friction between the ladder leg and the surface, preventing slippage of the ladder and possible injury.

### CROSS-REFERENCE TO RELATED APPLICATIONS

This application claims the benefit of U.S. Provisional Application No. 60/786,061 filed on Mar. 24, 2006. The disclosure of the above application is incorporated herein by reference.

### FIELD OF THE INVENTION

The present invention relates to the art of ladders. More particularly, this invention relates to the art of ladder stabilizing accessories for increasing the footprint, and thus stability, of a ladder when utilized on softer ground.

### BACKGROUND OF THE INVENTION

The use of ladder stabilizers are known in the prior art. More specifically, devices heretofore devised and utilized for the purpose of stabilizing ladders are known to consist basically of familiar, expected, and obvious structural configurations, notwithstanding the myriad of designs encompassed by the crowded prior art which have been developed for the fulfillment of countless objectives and requirements. Typical prior art related to this concept are shown in U.S. Pat. Nos. 4,415,062, 3,805,917, and 4,496,025.

The advantages of these and other art are obvious, but it has yet to be contemplated a simple and economical means of manufacturing a ladder stabilizer which is easy to use, can be used on a plurality of surfaces, both soft and firm, and can be removed, stored, or transported in a matter of seconds.

### SUMMARY OF THE INVENTION

It is therefore an object of the present invention to provide a stabilizer boot for a ladder to prevent the leg of a ladder from sinking into the ground when used on softer substrates, such as loose soil, sod, sand, or gravel.

A further object of the present invention is to provide a stabilizer boot for a ladder leg which is simply manufactured economically and easily attached or removed.

Another object of the present invention is to provide a ladder stabilizer boot which further provides a non-skid surface on the bottom for use of the ladder on smooth surfaces, wherein the boot will frictionally maintain the position of the ladder leg.

Another object of the present invention is to provide a ladder boot which can be placed on the bottom end of a ladder leg in either forward or backward orientations.

Another object of the present invention is to provide a ladder stabilizing boot which can be installed and removed from the ladder in a matter of seconds and is easily stored or transported.

These and other objects of the present invention will become more clear from the detailed descriptions and drawings contained herein describing a ladder stabilizing boot providing stability to a ladder leg when utilized upon softer substrate, such as loose soil, sod, sand or gravel, preventing sinking of the ladder leg into the substrate. This could possibly throw off the balance of the user, causing them or others bodily injury. Molded of a single element, preferably of plastic, polyester, nylon, rubber, or other suitable material, each stabilizer boot comprises a planar base, with a channel comprising a pair of parallel, slightly inwardly oriented walls molded into the base, for frictionally holding the sides of a ladder leg therewithin. Alternatively, the ladder boot may be utilized on smooth surfaces wherein an anti-skid surface on the bottom of the base provides friction between the ladder leg and the surface, preventing slippage of the ladder and possible injury.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an aerial perspective view of the preferred embodiment of the ladder boot in conjunction with a ladder;

FIG. 2 is a perspective view of the preferred embodiment of the ladder boot;

FIG. 3 illustrates an end view of the preferred embodiment of the ladder boot;

FIG. 4a illustrates a bottom side view of the ladder boot;

FIG. 4b illustrates a cross-sectional view of the bottom side of the ladder boot having a non-skid surface; and

FIG. 4c illustrates a cross-sectional view of the bottom side of the ladder boot having an alternative embodiment for the non-skid surface.

### DETAILED DESCRIPTION OF THE PREFERRED EMBODIMENTS

The following description of the preferred embodiment(s) is merely exemplary in nature and is in no way intended to limit the invention, its application, or uses.

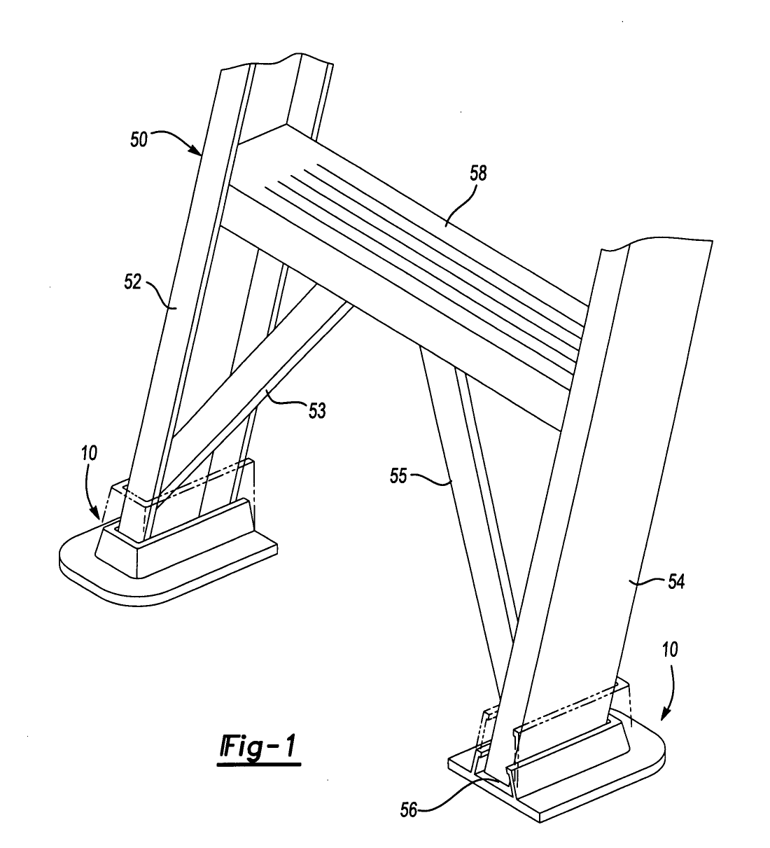

Referring now to the figures, in particular FIGS. 1 through 3, the ladder stabilizer boot 10 is shown. Manufactured or molded from a durable material such as plastic, nylon, rubber, or other polycarbonate having generally rigid, but deflectable properties in a monolithic element, stabilizer boot 10 is designed to be slid over the bottom end 56 of a ladder leg 54 or 52, giving the ladder 50 a larger and more stable platform upon which to rest. This is advantageous, as mentioned above, for utilizing the ladder on softer ground, such as loose soil, sod, sand, or gravel, wherein leg 56 of ladder 50 would have a tendency to sink in from the weight of a user, causing the ladder to tilt sideways and the user to possibly lose their balance and fall. Additionally, ladder boot 10 may be useful on ladders placed upon solid ground having a smooth surface, such as a polished floor, wherein the bottom side 24 provides a frictional surface, preventing ladder leg 56 from sliding out from beneath the user, possibly causing injury.

As illustrated in FIG. 1, the ladder boot can be placed over the end of standard rectangular cross-sectioned ladder leg 54, 52 in either orientation, facing forward or away from the incline angle of ladder 50, and does not interfere with any cross bracing 53 or 55, which may be present on the steps 58 of ladder 50.

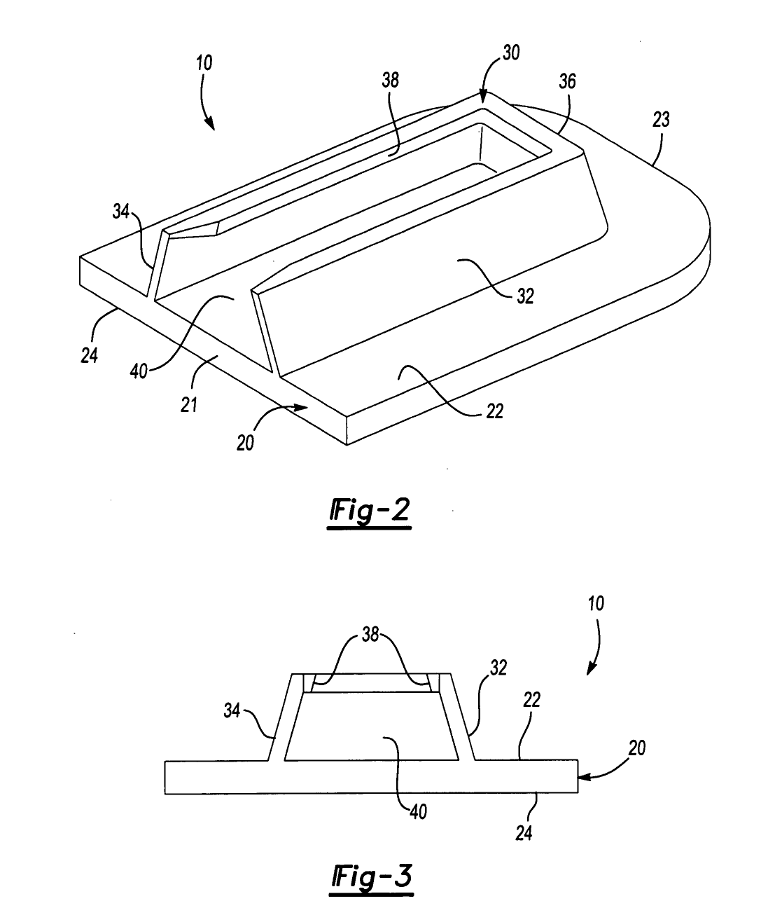

Referring to FIGS. 2 and 3, ladder stabilizer boot 10 is shown in greater detail. Molded as a single piece, each boot 10 comprises a planar base 20, having a generally rectangular shape with a toe end 23, and a heal end 21, which may embody rounded edges for aesthetics. Base 20, as mentioned, has a bottom side 24, which comprises a non-skid surface and a top-side 22, upon which the ladder leg 56 receiving channel 40 is centered upon. The channel 40 comprises a pair of parallel, slightly inward oriented side walls 32, 34 molded to base 20, with an end wall 36 connecting the two side walls 32, 34 near the toe end 23 of stabilizer boot 10. The heel ends of side walls 32, 34 terminate flush with heel end 21 of base 20 and proscribe channel 40 there between for receiving the bottom end of ladder leg 54, as shown in FIG. 1. Furthermore, the height of sidewalls 32, 34 can vary depending on the particular application or ladder utilized, also shown in FIG. 1.

The top edge 30 of side walls 32, 34 and the end wall 36 terminate in an inward oriented lip 38, which is located completely around the inside of the ladder receiving channel 40. The distance between the lip 38 of side wall 32 and side wall 34 is slightly less than the width of a ladder leg 54, but upon insertion over the end of the ladder leg, side walls 32 and 34 slightly deflect, allowing ladder leg 54 to be received there between, and is frictionally retained in position from lip 38 until it is desired to be removed therefrom. The inward oriented lip 38 of side walls 32, 34, proximate the heel end 21 of the invention, may comprise a bevel, as shown in FIGS. 2 and 3, providing for easier guidance of the ladder leg into channel 40.

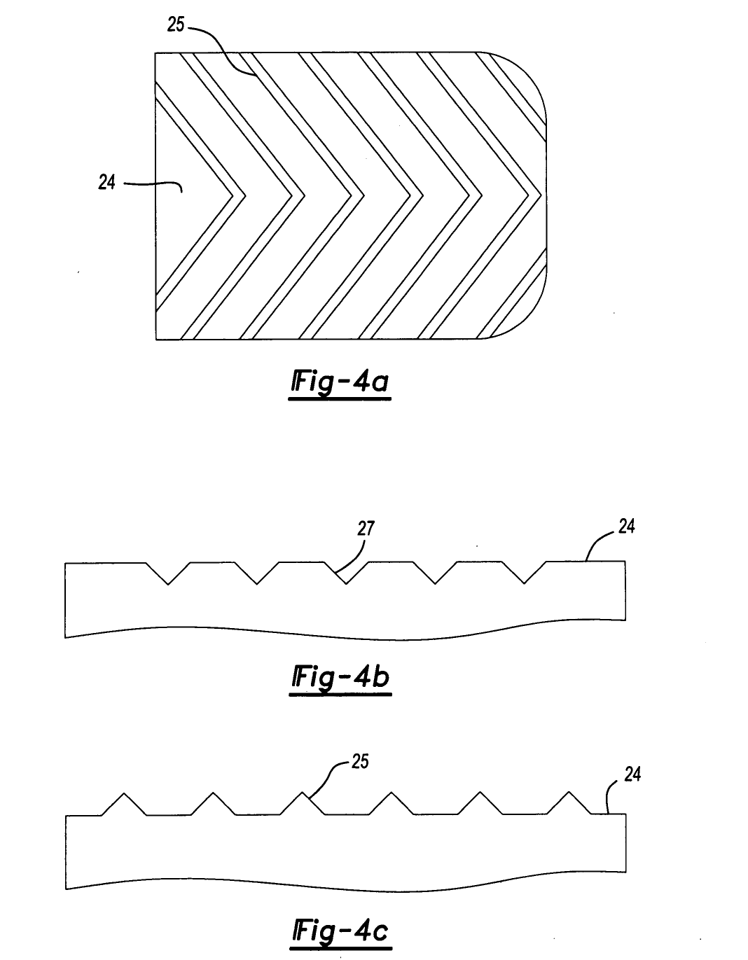

As stated above and shown in FIGS. 4a through 4c, bottom side 24 of base 20 embodies a non-skid surface or tread, formed therein, preventing ladder leg 56 from sliding out from beneath the user, possibly causing injury. The tread can be of any number of patterns, such as V-shaped ribs 25 of FIGS. 4a and 4c, but may alternatively comprise a series of grooves 27 within bottom side 24 of base 20. It is intended that variances in pattern, number, or tread design all fall within the scope of the present invention.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A ladder stabilizing device of monolithic construction utilized in pairs on the bottom ends of ladder legs, each of said devices comprising:
a planar base, said base having a generally rectangular shape comprising a toe end, a heal end, and a pair of parallel sides, said base further comprising a bottom side having a non-skid surface and a top side having a ladder leg receiving channel centered upon, said channel comprising:
a pair of parallel, deflectable, slightly inward oriented side walls molded to said base, said side walls comprising a heel end terminating flush with said heel end of said base;
an end wall, said end wall interconnecting the two side walls proximal the toe end of said stabilizing device, wherein said side walls proscribe a channel there between, proscribing a channel within which the bottom end of a ladder leg is snugly received between for receiving the bottom end of ladder leg, said side walls and said end wall having a continuous, inward oriented lip around the entire inside of the ladder receiving channel, wherein the distance between opposing side wall lips is less than the width of said ladder leg, providing frictional retention of said ladder leg within said channel when said side walls deflect outward when attached to said ladder, preventing movement of said stabilizing device in either the x, y, or z planes relative to said ladder leg until it is desired to be removed there from, said inward oriented lip of side walls proximate the heel end of said stabilizing device further comprising a bevel allowing easier insertion of said ladder leg into said channel.

2. The ladder stabilizing device of claim 1, wherein said non-skid surface of said base member comprises a series of grooves molded into the bottom surface of said base member.

3. The ladder stabilizing device of claim 1, wherein said stabilizing device is molded from one of the following materials: plastic, nylon, rubber, or other polycarbonate.
